(19) United States
(12) Patent Application Publication
(10) Pub. No.: US 2026/0330985 A1
(43) Pub. Date: Oct. 22, 2026

(54) SYSTEM AND METHOD FOR NON-COOPERATIVE AIRCRAFT DETECTION USING CROSS-MODAL GEOMETRIC VALIDATION

(71) Applicant: Richard Joseph Mitchell, TAVARES, FL (US)

(72) Inventor: Richard Joseph Mitchell, TAVARES, FL (US)

(21) Appl. No.: 19/383,601

(22) Filed: Nov. 8, 2025

(51) Int. Cl. G08G 5/80; G01S 17/933; G08G 5/57

(52) U.S. Cl. CPC G08G 5/80; G08G 5/57; G01S 17/933

(57) ABSTRACT

A Detect-and-Avoid (DAA) system and method for Unmanned Aircraft Systems (UAS) for detecting non-cooperative aircraft. The system includes a multi-modal sensor suite comprising a spatial sensor (e.g., LiDAR) and a radiometric sensor (e.g., thermal camera). A cross-modal validation module performs Cross-Modal Geometric Validation (CMGV) by correlating immutable physical properties of a detected object across the modalities. This correlation involves validating a three-dimensional geometric shape, derived from the spatial sensor, by confirming its spatial and dimensional congruence with a co-located thermal signature from the radiometric sensor. By further analyzing the object's structural rigidity over sequential spatial data frames, the system can reliably distinguish a rigid aircraft structure from non-rigid, flapping avian wildlife, enabling high-confidence classification for initiating regulatory avoidance maneuvers during Beyond Visual Line of Sight (BVLOS) operations.

### BACKGROUND OF THE INVENTION

### 1. Technical Field

The present invention relates generally to aviation safety systems, and more particularly to Detect-and-Avoid (DAA) capabilities for Unmanned Aircraft Systems (UAS). Specifically, it concerns the reliable detection, classification, and tracking of non-cooperative aircraft during Beyond Visual Line of Sight (BVLOS) operations.

### 2. Background Art

The integration of Unmanned Aircraft Systems (UAS), or drones, into the National Airspace System (NAS) requires stringent safety protocols. Regulatory frameworks, such as the anticipated FAA Part 108 rules for BVLOS operations, mandate that UAS must possess robust Detect-and-Avoid (DAA) capabilities to prevent mid-air collisions.

A DAA system enables a UAS to detect other air traffic and execute maneuvers to remain well clear. Detecting “cooperative” aircraft—those equipped with electronic conspicuity technologies such as Automatic Dependent Surveillance-Broadcast (ADS-B) or transponders—is relatively straightforward. However, a critical technical challenge and regulatory hurdle is the reliable detection of “non-cooperative” targets. Non-cooperative targets are aircraft that do not broadcast their position electronically, such as gliders, hot air balloons, agricultural aircraft, or older general aviation aircraft operating without active transponders.

Manned aviation stakeholders require DAA systems to be effective against non-cooperative targets in all classes of airspace. Existing solutions based on single sensor modalities have proven insufficient:
Visual cameras (electro-optical sensors) are highly susceptible to environmental conditions, including darkness, sun glare, fog, and precipitation.
Radar systems, while less affected by weather, often lack the necessary resolution to accurately classify small targets and struggle to distinguish between small aircraft and other objects, such as birds or ground clutter.

The limitations of these existing technologies create a difficult perception problem that single-modality systems cannot solve reliably. Sensor fusion, particularly involving LiDAR and thermal cameras, is known for general object detection and mapping in autonomous systems, especially in adverse conditions. However, applying this fusion specifically to achieve high-confidence classification that discriminates between rigid aircraft and non-rigid avian wildlife remains a significant technical challenge in meeting DAA safety standards. Therefore, there exists a critical need for a robust perception system capable of detecting and classifying non-cooperative aircraft with high confidence, regardless of environmental conditions, to meet the safety standards required for BVLOS operations.

### BRIEF SUMMARY OF THE INVENTION

The present invention addresses the limitations of the prior art by providing a novel perception system and method termed “Cross-Modal Geometric Validation” (CMGV) for the reliable detection and classification of non-cooperative aircraft.

This system integrates data from multiple, diverse sensor modalities and correlates the immutable physical properties of detected objects across these modalities to achieve high-confidence classification.

In one aspect of the invention, a DAA system for a UAS comprises a multi-modal sensor suite configured to scan the surrounding airspace. This suite includes at least one spatial sensor capable of generating three-dimensional structural data (e.g., LiDAR) and at least one radiometric sensor capable of detecting energy signatures (e.g., a thermal camera).

The core of the invention is a perception processing pipeline configured to execute the Cross-Modal Geometric Validation. When an object is detected by one sensor modality, the system actively seeks corroborating data from the other modality at the corresponding spatial location. The inventive step involves correlating these distinct data types—specifically, validating an object's three-dimensional geometric structure (derived from spatial data) by confirming its dimensional and spatial congruence with a co-located thermal signature (derived from radiometric data).

This cross-modal correlation allows the system to classify non-cooperative targets with significantly higher confidence than single-modality systems. It enables the distinction between threats and non-threats by analyzing the congruence of physical properties, most critically using sequential spatial data to determine the object's structural rigidity over time. For instance, the system can distinguish a bird (characterized by a small thermal signature and a non-rigid, flapping motion profile) from a small aircraft (characterized by a larger thermal signature indicative of an engine and a rigid 3D structure). This approach provides a robust technical solution to the non-cooperative DAA problem, overcoming environmental limitations and providing the classification confidence needed for regulatory approval of BVLOS operations.

### BRIEF DESCRIPTION OF THE SEVERAL VIEWS OF THE DRAWING

FIG. 1 is a block diagram illustrating the system architecture of the Cross-Modal Geometric Validation perception system (100), according to an embodiment of the invention.

FIG. 2 is a flowchart illustrating the method (200) for non-cooperative aircraft detection using cross-modal correlation, according to an embodiment of the invention.

### DETAILED DESCRIPTION OF THE INVENTION

The following detailed description illustrates the invention by way of example and not by way of limitation. The description will enable one skilled in the art to make and use the invention. The present invention is directed to a system and method for detecting and avoiding non-cooperative aircraft using Cross-Modal Geometric Validation (CMGV).

In the context of the present invention, the term “immutable physical properties”—as used throughout the claims—is formally defined herein to mean the specific, quantifiable physical attributes of a detected object that are correlated between sensor modalities to achieve high-confidence classification. These properties include, but are not limited to: (1) Three-Dimensional Geometric Shape (e.g., size, length, and spatial boundaries derived from spatial data); (2) Structural Rigidity (e.g., the assessment of non-deformability over sequential frames of spatial data); and (3) Measured Thermal Radiation Profile (e.g., intensity and distribution of the heat signature derived from radiometric data).

### 1. System Architecture

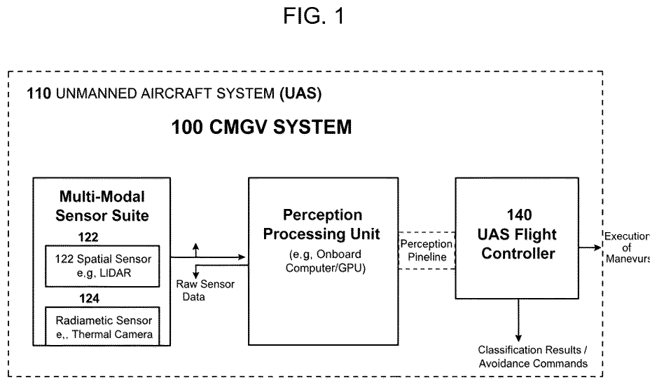

Referring to FIG. 1, the system (100) comprises an airborne perception platform suitable for integration into a UAS (110). The platform includes a multi-modal sensor suite (120) and an onboard perception processing unit (130).

Multi-Modal Sensor Suite (120): The suite is configured to provide comprehensive, overlapping coverage of the surrounding airspace. In a preferred embodiment, the suite includes:
Spatial Sensor (122): Preferably a high-resolution LiDAR (Light Detection and Ranging) sensor. LiDAR provides precise, three-dimensional point cloud data of the environment, capturing the geometric shape, size, range, and motion characteristics of objects, operating independently of ambient lighting conditions. This sensor provides the structural data necessary to determine geometric shape and rigidity.
Radiometric Sensor (124): Preferably a thermal imaging sensor (e.g., Long-Wave

Infrared-LWIR camera). This sensor detects infrared radiation emitted by objects. This sensor is crucial for identifying heat signatures associated with aircraft engines or aerodynamic friction, effective in day, night, and through certain atmospheric obscurants.

Perception Processing Unit (130): A computing module (e.g., embedded GPU or FPGA) responsible for executing the perception pipeline (132), including sensor data fusion, object detection, tracking, and the Cross-Modal Geometric Validation algorithm. The processing unit (130) is interfaced with the UAS flight controller (140) to execute avoidance maneuvers if necessary.

### 2. The Perception Pipeline and Cross-Modal Geometric Validation

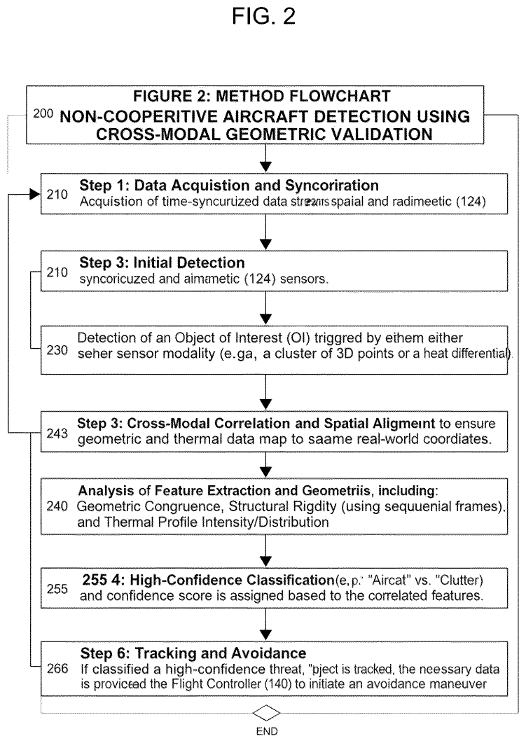

The perception pipeline (132) continuously processes data from the multi-modal sensor suite (120). The process is detailed in the flowchart of FIG. 2.

Step 1: Data Acquisition and Synchronization (210): The spatial sensor (122) and the radiometric sensor (124) continuously scan the airspace. For the subsequent validation steps to be accurate, the data streams are precisely time-synchronized and spatially registered using coordinate transformation models and calibration parameters.

Step 2: Initial Detection (220): Initial detection of an Object of Interest (OI) can be triggered by either modality. For example, the radiometric sensor may identify a region based on a temperature differential, or the spatial sensor may detect a cluster of points at range.

Step 3: Cross-Modal Correlation and Spatial Alignment (230): Once an OI is detected in one modality, the system aligns the sensor data streams and actively seeks corroborating evidence in the other modality at the corresponding spatial location (azimuth and elevation).
Thermal-to-Geometric Validation: If a thermal signature is detected, the system analyzes the 3D point cloud data at that location to identify a corresponding geometric structure.
Geometric-to-Thermal Validation: If a geometric object is detected via the spatial sensor, the system analyzes the thermal data at that location to identify if the object possesses a thermal signature consistent with an aircraft.

Step 4: Feature Extraction and Geometric Validation (240): The system analyzes the immutable physical properties derived from the correlated data:
Geometric Congruence: Determining if the 3D shape aligns spatially and dimensionally with the thermal signature. A strong correlation suggests the heat source is integral to the physical object and not merely a background event.
Structural Analysis (Rigidity): Analyzing the spatial data over time (e.g., sequential LiDAR frames) to assess the object's rigidity. Aircraft exhibit rigid structures, whereas avian wildlife exhibits deformable or articulating structures (flapping). This analysis provides a high-confidence metric for bird discrimination, which is critical for minimizing false positives.
Thermal Profile Analysis: Assessing the intensity and distribution of the heat signature to differentiate between an aircraft engine (intense, concentrated heat) and other heat sources (e.g., lower, distributed biological heat of a bird).

Step 5: High-Confidence Classification (250): Based on the aggregated evidence from the CMGV, the OI is classified and a confidence score is assigned. An object exhibiting a significant thermal signature co-located with a rigid, appropriately sized 3D structure and a motion profile consistent with aviation will be classified as a potential aircraft with high confidence.

Step 6: Tracking and Avoidance (260): Objects classified as aircraft threats are tracked, and the data is passed to the flight controller (140) to initiate regulatory avoidance maneuvers if necessary.

What is claimed is:

1. A Detect-and-Avoid (DAA) system for an Unmanned Aircraft System (UAS) for the detection of non-cooperative aircraft, the system comprising:
a. A multi-modal sensor suite configured to scan the airspace surrounding the UAS, the suite comprising at least one spatial sensor configured to generate three-dimensional structural data and at least one radiometric sensor configured to detect energy signatures;
b. A perception processing unit configured to receive data from the multi-modal sensor suite; and
c. A cross-modal validation module executed by the perception processing unit, wherein the module is configured to:
i. Detect an object in the airspace via a first sensor modality from the multi-modal sensor suite;
ii. Identify the spatial location of the detected object;
iii. Analyze data from a second sensor modality from the multi-modal sensor suite at the identified spatial location; and
iv. Correlate immutable physical properties derived from the first sensor modality with immutable physical properties derived from the second sensor modality to validate and classify the detected object, wherein the immutable physical properties include the object's three-dimensional geometric shape, structural rigidity, and measured thermal radiation profile.

2. The system of claim 1, wherein the at least one spatial sensor is a LiDAR (Light Detection and Ranging) sensor.

3. The system of claim 1, wherein the at least one radiometric sensor is a thermal imaging camera.

4. The system of claim 1, wherein the immutable physical properties correlated by the cross-modal validation module include a three-dimensional geometric shape derived from the spatial sensor and a thermal signature derived from the radiometric sensor.

5. The system of claim 4, wherein the cross-modal validation module validates a detection by confirming the spatial co-location and geometric congruence between the thermal signature and the three-dimensional geometric shape.

6. The system of claim 1, wherein the cross-modal validation module is further configured to analyze the structural rigidity of the detected object over time using the three-dimensional structural data.

7. The system of claim 6, wherein the analysis of structural rigidity is used to distinguish between a rigid aircraft structure and a non-rigid object, such as avian wildlife exhibiting a flapping motion profile.

8. The system of claim 1, wherein the perception processing unit is further configured to assign a confidence score to the classification based on the strength of the correlation of the immutable physical properties.

9. The system of claim 1, wherein the classification determines whether the detected object is a non-cooperative aircraft with high confidence, enabling the UAS to initiate an avoidance maneuver.

10. A method for detecting non-cooperative aircraft from an Unmanned Aircraft System (UAS), the method comprising:
a. Scanning the airspace surrounding the UAS using a multi-modal sensor suite comprising at least a first sensor modality providing spatial data and a second sensor modality providing radiometric data;
b. Detecting an object via the first sensor modality;
c. Determining the spatial location of the detected object;
d. Analyzing data from the second sensor modality corresponding to the determined spatial location;
e. Performing Cross-Modal Geometric Validation by correlating immutable physical properties of the object derived from the first sensor modality with immutable physical properties of the object derived from the second sensor modality; and
f. Classifying the detected object based on the results of the Cross-Modal Geometric Validation.

11. The method of claim 10, wherein the first sensor modality is LiDAR and the second sensor modality is thermal imaging.

12. The method of claim 11, wherein performing Cross-Modal Geometric Validation comprises correlating a three-dimensional geometric structure of the object derived from the LiDAR data with a thermal signature of the object derived from the thermal imaging data.

13. The method of claim 12, further comprising analyzing the rigidity of the three-dimensional geometric structure over time.

14. The method of claim 13, wherein the classification step distinguishes between a non-cooperative aircraft and avian wildlife based on the correlated thermal signature, the three-dimensional geometric structure, and the analysis of rigidity.

15. The method of claim 10, further comprising analyzing a motion profile of the detected object using the spatial data to distinguish between aircraft flight dynamics and non-aircraft movement, such as a flapping motion.

16. The system of claim 1, wherein the perception processing unit is further configured to time-synchronize and spatially register data streams from the at least one spatial sensor and the at least one radiometric sensor prior to analysis by the cross-modal validation module.

17. The system of claim 1, wherein the cross-modal validation module, when correlating immutable physical properties, is further configured to analyze a thermal profile of the measured thermal radiation to distinguish between a concentrated heat signature associated with an aircraft engine and a distributed biological heat signature.

18. The system of claim 1, wherein the first sensor modality is the radiometric sensor, and the second sensor modality is the spatial sensor, wherein the detection is triggered by identifying a thermal signature.

19. The system of claim 1, wherein the first sensor modality is the spatial sensor, and the second sensor modality is the radiometric sensor, wherein the detection is triggered by identifying a geometric object.

20. The method of claim 10, further comprising, prior to said detecting, time-synchronizing and spatially registering the spatial data and the radiometric data to establish a common coordinate framework.

21. The method of claim 10, wherein performing Cross-Modal Geometric Validation further comprises analyzing a thermal profile of the object derived from the radiometric data to distinguish between an engine heat signature and a biological heat signature.
